(19) United States
(12) Patent Application Publication
(10) Pub. No.: US 2014/0034597 A1
(43) Pub. Date: Feb. 6, 2014

(54) Unloading device for containers and method for operating them

(71) Applicant: GE Energy Power Conversion GmbH, Brelin (DE)

(72) Inventors: Lutz Steinhaus, Berlin (DE); Tobias Tessmer, Berlin (DE)

(73) Assignee: GE Energy Power Conversion GmbH, Brelin (DE)

(21) Appl. No.: 13/957,233

(22) Filed: Aug. 1, 2013

(30) Foreign Application Priority Data
Aug. 1, 2012 (DE) 102012213604.5

(51) Int. Cl. B66C 13/18; B66C 19/00

(52) U.S. Cl. CPC B66C 13/18; B66C 19/002
USPC 212/276; 212/71

(57) ABSTRACT

A loading device for containers, which is provided with a travel carriage, which can move on a rail. Furthermore, there are two load handling devices which are assigned to the travel carriage, and which are kept fixed to the travel carriage with the help of the supporting cables. Each of the load handling devices can be raised or lowered, and the two load handling devices can be coupled mechanically with each other. A distance sensor is assigned to each of the load handling devices, with which the distance of the load handling devices from the travel carriage can be determined.

### CROSS-REFERENCE TO RELATED APPLICATIONS

This application claims foreign priority under 35 U.S.C. §119 to co-pending German Patent Application No. 102012213604.5, filed Aug. 1, 2012, which is hereby incorporated by reference in its entirety.

### BACKGROUND OF THE INVENTION

Embodiments of the present invention relate to a loading device for containers as well as a method for operating them.

A loading device for containers is known, for example, from the WO 2010/007514 A2 (“Fantuzzi”). FIG. 1 of Fantuzzi, for instance, shows two load bearing load handling devices 2, 3, to each of which a spreader 6, 11 is attached in a detachable manner, against which, in turn, containers C1, C2 can be held in a detachable manner. At each of the load handling devices 2, 3, pulleys 7, 13 are arranged, over which the supporting cable or ropes 8, 14, from which the load handling devices 2, 3 are suspended, are guided.

Normally, in such loading devices, a travel carriage is assigned to the two load handling devices, wherein the travel carriage can be moved on rails in the region of a loading bridge. The travel carriage is provided with hoisting drums, over which the supporting cable or role of the respective load handling devices can be wound and unwound. Alternatively, the hoisting drums along with the corresponding drive motors can also be located in a machine housing on the loading bridge. With the help of the travel carriage and the supporting cable, it is possible to move both the containers in the direction of the rails and to raise or lower them in the vertical direction.

When the loading device is in use, the two load handling devices can be mechanically coupled with each other, so that two containers can always be loaded at the same time. Alternatively, the coupling can be isolated, so that then only one of the two load handling devices can be used for loading and unloading. The other load handling devices will be parked in this case. For the said coupling and decoupling a corresponding actuation can be provided.

If the two load handling devices are mechanically coupled with each other, then it is necessary here that the two load handling devices should be at exactly the same height, as much as possible. This condition cannot be met in a simple manner, since the supporting cables undergo an expansion over time owing to the loads that are transported, which could be different at the two load handling devices. If this condition is not satisfied, then, for safety reasons, the coupling does not happen at all, or is resolved again immediately.

### BRIEF DESCRIPTION OF THE INVENTION

Embodiments of the present invention provide a loading device for containers. The loading device comprises at least two load handling devices and incorporates a simple mechanical coupling of the at least two load handling devices.

According to an embodiment of the present invention, there is provided a loading device. The loading device has a travel carriage, which can usually be moved on rails. Further, two load handling devices are envisaged, which are assigned to the travel carriage, and with the help of which the supporting cables are kept attached to the travel carriage. Each of the load handling devices can be raised and lowered, and the two load handling devices are can be coupled mechanically with each other. A distance sensor is assigned to each of the load handling devices, with which the distance of the load handling device from the travel carriage can be determined.

With the help of the distance sensor the distance of the concerned load handling device from the travel carriage can be determined. Based on this, at least one of the two load handling devices can be raised or lowered in such a way that the two load handling devices are then on the same level a far as possible. The two load handling devices can then be mechanically coupled with each other easily.

In an embodiment, the distance sensor is designed in such a way that an extension of the corresponding supporting cables will not have any influence on the determination of the distances. As either of the load handling devices is raised or lowered, such an extension of a supporting cables can also be compensated in this way.

In an embodiment of the present invention, an inclination sensor is assigned to the load handling devices, with which the spatial alignment of the load handling device with respect to the horizontal can be determined. With the help of the inclination sensor or the inclination sensors it is possible to align the corresponding load handling devices in the horizontal plane. In this position, it is particularly useful to carry out the described distance measurement.

According to an embodiment of the present invention, there is provided a method. In the method, for each of the two load handling devices the current distance from the travel carriage is determined, depending on the current distance a difference is determined, and at least one of the two load handling devices is raised or lowered depending on the difference, in such a way that the difference is reduced to zero. In this way, any difference in the two load handling devices in terms of their height can be balanced.

In an embodiment, a reference distance is determined for each of the two load handling devices, if for each load handling device a difference between the reference distance and the current distance is determined, and if at least one of the two load handling devices is raised or lowered in such a way that the difference tends to zero. With the help of the reference-distance, it is possible to determine at any time the extent to which the supporting cables have already undergone an extension. This can be used to carry out maintenance, especially a replacement of the supporting cables.

In an embodiment of the method, the spatial alignment of the load handling devices with respect to the horizontal is determined with the help of an inclination sensor that is assigned to the load handling device, and the supporting cables are manipulated in such a way that the load handling devices are in the horizontal plane. In this way, the load handling devices can be aligned in the horizontal plane. This can be done before carrying out the distance measurement.

According to an embodiment of the present invention, there is provided a control unit. The control unit comprises a loading device according to an embodiment and is configured to execute a method according to an embodiment.

### BRIEF DESCRIPTION OF THE DRAWINGS

Other features, possible applications and advantages of the present invention arise out of the following description of sample manifestations of the present invention, which are represented in the corresponding figures. Here, all the described or depicted features constitute the subject of the invention, either individually or in any desired combination, regardless of the fact that they have been summarized together in the patent claims or in their reverse relation and independent of their formulation or representation in the description or in the figures. In the drawings:

FIG. 1 shows a schematic lateral view of a part of a sample manifestation of a loading device for containers; and

FIGS. 2A, 2B and 2C show schematic flow charts of sample manifestations of the method according to embodiments of the present invention for operating the loading device shown in FIG. 1.

### DETAILED DESCRIPTION OF THE INVENTION

Harbors and loading docks often employ a loading device with which containers are loaded onto and off of ships, trucks, trains or other transport vehicles. Such a loading device for containers often takes on the form of a gantry crane, which can be moved along a quay and hence is essentially parallel to a ship that is moored there. The loading device has a loading bridge with several rails, which are arranged at a height such that they are essentially located above a loading area that is present on the ship. The rails can be moved to a position in which they are approximately transverse with respect to the quay and hence also approximately perpendicular to a ship that is moored there. In this position the rails project over and above the ship. At least one travel carriage, which can be moved in the direction of the rails, is arranged on these rails. With the help of this loading device containers can be loaded onto or off the ship.

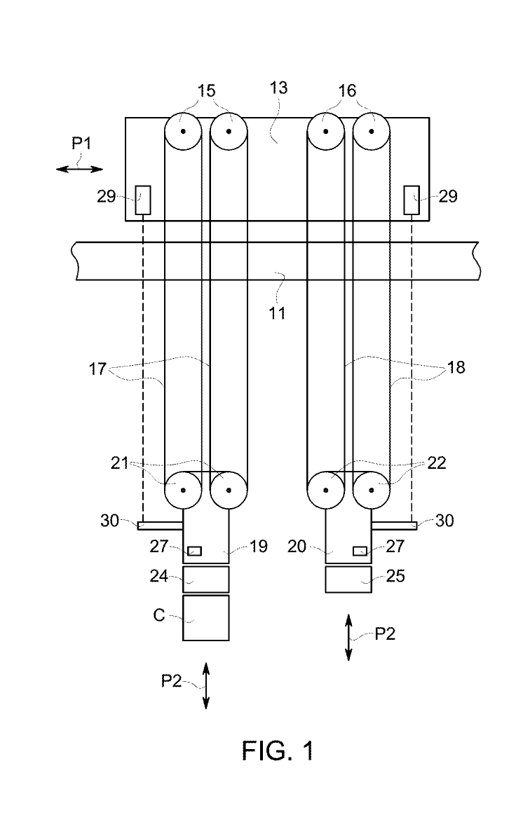

FIG. 1 shows a rail 11 of such a loading device, on which a travel carriage 13 is arranged such that it can travel. The direction of travel of the travel carriage 13 is indicated by an arrow P1. The travel carriage 13 is provided with castors 15, 16, over which the supporting cables 17, 18 run. Two load handling devices 19, 20 are assigned to the travel carriage 13, wherein each of the load handling devices 19, 20 in turn is provided with castors 21, 22, over which the supporting cables 17, 18 run.

At each of the load handling devices 19, 20 a spreader 24, 25 is fixed in a detachable manner. Each of the spreaders 24, 25 is essentially a rectangular frame, which spans a surface area that corresponds approximately to the upper surface of a container. FIG. 1 shows both the spreaders 24, 25 from the side, so that the above mentioned frame extends vertical to the plane of the drawing in FIG. 1 and is therefore not visible.

At each of the spreaders 24, 25, at the corners of the respective frames in particular, braces are provided, with which the spreaders 24, 25 can be attached to the upper surface of such containers in a detachable manner. FIG. 1 shows as an example such a container C, which is fixed on the spreader 24.

In an embodiment, the castors 21, 22 are arranged on the two load handling devices 19, 20 in such a way that they are essentially located at the corners of the frame of the respective corresponding spreaders 24, 25. The castors 15, 16 are arranged on the travel carriage 13 in such a way that the supporting cables 17, 18 are essentially in the vertical plane if the corresponding load handling devices 19, 20 lie below the travel carriage 13.

In an embodiment, four supporting cables 17, 18 and hence also four castors 15, 16, 21, 22 are provided in each case for each of the load handling devices 19, 20 and hence at the travel carriage 13. Due to the lateral view of the loading device that is shown in FIG. 1, only two of these castors are shown.

In an embodiment, not shown in the figures, there is at least one hoisting drum on the travel carriage 13 that is driven by an electric motor, with which the supporting cables 17, 18 can be wound up or released for the respective load handling devices 19, 20. In this way, the respective load handling devices 19, 20 can be raised or lowered along with the corresponding spreaders 24, 25 and the containers C that may be attached to them. This is indicated in the FIG. 1 through the arrows P2.

In the region of the travel carriage 13, a working cylinder that can be operated hydraulically, for instance, is assigned to each of the supporting cables 17, 18 in a manner that is not depicted here. Each working cylinder in turn is held fixed and contains a piston on the other side, to which a deflection roller is fastened, over which the corresponding supporting cable 17, 18 is guided. Each of the deflection rollers is arranged with respect to the corresponding supporting cables 17, 18 in such a way that an adjustment of the piston within the working cylinder results in an elongation or shortening of the distance that is to be covered by the supporting cable 17, 18.

At the two load handling devices 19, 20 devices are provided, using which the two load handling devices 19, 20 can be mechanically coupled with each other. With regard to these devices, reference is made, for instance, to the WO 2010/007514 A2 that was mentioned at the outset. The actuation of the mechanical coupling can be done hydraulically or with the help of an electric motor or in any other way.

During the operation of the loading device the two load handling devices 19, 20 can be mechanically coupled with each other, so that two containers can always be loaded together. Alternatively, the coupling can be separated, so that then just one of the two load handling devices 19, 20 can be used for loading and unloading, which is normally the load handling device on the sea side.

An inclination sensor 27 is arranged at each of the two load handling devices 19, 20. If we assume a horizontal surface, then each of the inclination sensors 27 is suitable for recording any deviation of the surface it is scanning, with respect to the horizontal. This recording includes, in particular, an x-coordinate and a y-coordinate of the horizontal surface or of the surface that is scanned by the respective inclination sensors 27. Thus, it is possible to determine the spatial orientation of the two load handling devices 19, 20 and hence also the spatial orientation of the two spreaders 24, 25 with respect to the horizontal, with the help of the inclination sensors 27.

It should be noted that the inclination sensor 27 could also be arranged on the spreaders 24, 25.

A distance sensor is assigned to each of the two load handling devices 19, 20, with the help of which the distance of the concerned load handling devices 19, 20 from the travel carriage 13 can be recorded.

The distance sensor could be any device using which the distance of the respective load handling devices 19, 20 from the travel carriage 13 can be measured directly. Here, a direct distance measurement means that an elongation of the supporting cables 17, 18 will not have any impact on the measurement of the corresponding distance sensor.

If, for instance, an angular position of one of the existing hoisting drums is measured and this angular position is used along with the diameter of the winch of the hoisting drum to deduce the length of the wound supporting cables and hence to a distance of the corresponding load handling devices from the travel carriage, then, this is not considered a direct measurement of the distance.

Furthermore, it should be noted that the distance sensor can be of any kind. It could be a mechanical or electrical or electromagnetic or optic or acoustic sensor, or any desired combination of these. The distance sensor can be designed so that it is contact free, or it could also be a device in which the travel carriage 13 is coupled with the respective, corresponding load handling devices 19, 20.

If, for instance, one cable roll were to be attached in each case to the travel carriage 13, from which a cable were to be unwound only for the purpose of measuring the distance, which were to be fastened to the corresponding load handling devices 19, 20, and if the length of the cable that is unwound and hence the distance were to be deduced from the angular position of the cable rolls, then this would represent a direct distance measurement, since the elongation of the supporting cables 17, 18 would not play any role in this case.

In an embodiment, each of the distance sensors has a device 29 for sending and receiving laser signals, which is mounted in particular on the travel carriage 13. Furthermore, each of the distance sensors has a reflector 30, which is located in particular on the respective load handling devices 19, 20. Here the reflector 30 is arranged and oriented in such a way that a laser signal that is sent out by the device 29 in an operational state of the load handling device 19, 20 that is suitable for a distance measurement is reflected by the reflector 30 and is returned to the device 29. This is shown in the FIG. 1 in dotted lines.

It should be noted that the device 29 and the corresponding reflector 30 can also be arranged on the other side. Thus, it is possible in particular to arrange the device 29 and the reflector 30 approximately at the center of the load handling devices 19, 20. If necessary, the reflector 30 can also be fixed to the spreaders 24, 25. Of course, the device 29 and the reflector 30 can also be arranged interchanged.

In addition to this, it may be pointed out that the distance sensors cannot be provided in such a way that they can be used to record the distance of the respective load handling devices 19, 20 from the travel carriage 13, but it is also possible to provide the distance sensors in such a way that they can be used to record distance of the respective load handling devices 19, 20 from a fixed horizontal surface, such as from a so called fixing strut that is fixed on the floor.

The described loading device is provided with a control unit which is connected with the den inclination sensors 27, the device 29, the working cylinders that can be operated hydraulically and the electric motors that drive the hoisting drums. Furthermore, the control unit is connected with the electrical or hydraulic actuators of the coupling of the two load handling devices 19, 20. The control unit is, in particular, a programmable computing unit, with which the method described below can be executed.

With the help of the control unit, it is possible to also operate the loading device so that only one of the two load handling devices 19, 20 alone is used for loading the containers, or that both load handling devices 19, 20 can be coupled mechanically with each other in a manner that is not depicted here, and then both the load handling devices 19, 20 are used simultaneously for loading the container. Furthermore, the control unit can be used to execute the above mentioned mechanical coupling of the two load handling devices 19, 20, as well as their decoupling.

In particular, in the coupling of the two load handling devices 19, 20 it is necessary for the two load handling devices 19, 20 to be as precisely at the same level as possible. As explained below, this can also be achieved with the help of the Control unit.

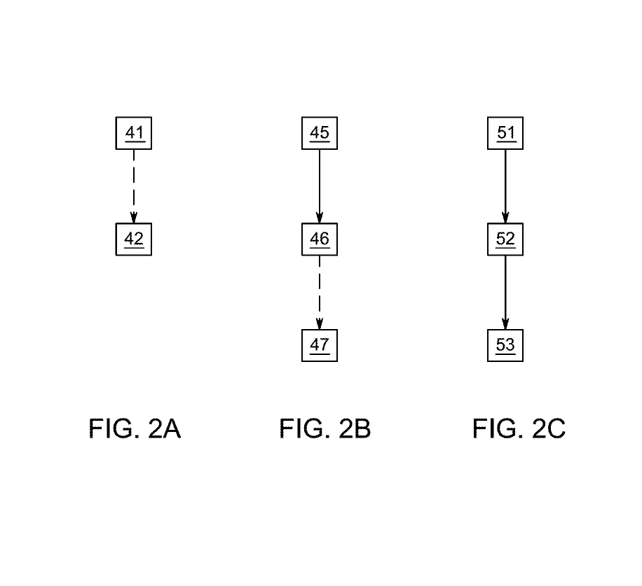

During the operation of the loading device reference inclinations are determined by the control unit, as shown in the FIG. 2a. The following explanations of the FIG. 2a here refer to the load handling device 19, for instance, but are applicable equally to the load handling device 20.

In a Step 41 the load handling device 19 is lowered and placed on a horizontal surface. This horizontal surface could be, for instance, a so-called fixing strut that is present on the floor and which is normally oriented horizontally, or even any other surface which is known to be horizontal. After the inclination sensor 27 that is located on the load handling device 19 has been placed, those inclinations in the direction of the x-coordinate and the y-coordinate, with which the position of the inclination sensor 27 deviates from the horizontal, are determined. These inclinations are saved as reference-inclinations for the horizontal of the load handling device 19 in the control unit.

In a Step 42 then, the load handling devices 19 are raised from the horizontal surface, so that it hangs freely from the supporting cables 17. The inclination sensor 27 again determines those inclinations in the direction of the x-coordinate and the y-coordinate, with which the position of the inclination sensor 27 now deviates from the horizontal. These current inclinations are compared with the reference-inclinations.

The result of comparison represents the inclination of the load handling device 19 in the x- and y-direction with respect to the horizontal. With the help of the specified characteristic curves, this result of comparison is converted into displacement paths for the working cylinder which can be operated hydraulically. Here, the characteristic curves are specified in such a way that an inclination of the load handling device 19 of 4 degrees in the y-direction will result in an outward movement of the working cylinders by a definite distance.

As explained, one of the working cylinders is assigned to each of the supporting cables 17. Then, if those two working cylinders, whose corresponding supporting cables 17 are arranged on a common longitudinal side of the load handling device 19, then, an inclination of the load handling device 19 in the y-direction, for instance, will change. In this way, the above mentioned sample inclination of 4 degrees of the load handling device 19 can be compensated.

Depending on the above mentioned comparison, therefore, one or more of the working cylinders which can be operated hydraulically is actuated by the control unit in such a way that it is moved in or out by the definite displacement path. The result of this is an elongation or shortening of the path that has to be covered by the supporting cables 17, which also means that the inclination of the load handling device 19 changes accordingly based on the shortened or extended supporting cable 17. Here, the characteristic curves or the displacement paths of the working cylinder are specified in such a way that the load handling devices 19 and hence even the corresponding spreaders 24 are then in the horizontal plane.

It should be noted that the Step 42 that has been described above need not necessarily be executed after or together with the Step 41. It is also possible to execute the Step 42 independent of the Step 41 at a different point in time. Here, the Step 42 can be executed once or repeatedly. If necessary, the load handling device 19 need not be lifted any more, if it is already hanging freely from the supporting cable 17.

Furthermore, it should be noted that the operating state that was mentioned in connection with the distance sensors which is suitable for a distance measurement, can be attained by executing the Step 42 and making the respective load handling devices 19, 20 lie in the horizontal plane.

During the operation of the loading device reference-distances are determined by the control unit, as explained with the help of the FIG. 2b below. In particular the reference-distances are determined if, for instance, new supporting cables 17, 18 have been mounted.

In a Step 45 the two load handling devices 19, 20 are moved to a height H. Here, the height H means a definite vertical distance from a surface, such as the floor or from a so-called fixing strut. The height H can be specified or it can lie within a specified range of heights. The height H of the concerned load handling devices 19, 20 here is set with the help of the respective hoisting drums, with which the supporting cables 17, 18 of the respective load handling devices 19, 20 are wound or unwound.

For instance, it is possible to have a sensor assigned to the hoisting drum or the electric motor that drives the hoisting drum, using which the angular position of the hoisting drum can be determined. With due consideration for the winding diameter of the hoisting drum, this can be used to calculate the length of the supporting cables 17, 18, which has been unwound from the hoisting drum. From this the height H of the load handling devices 19, 20 can be derived.

In an embodiment, it is also possible to have the electric motor that drives the hoisting drum designed as a step motor, for instance, and in this way, it can approach the height H of the load handling devices 19, 20 directly without an assigned sensor.

If the Step 42 has not been executed so far, then the working cylinder which can be operated hydraulically is actuated at this point, in accordance with Step 42, so that the load handling devices 19, 20 are aligned horizontally.

Once the load handling devices 19, 20 are located at the height H and if they are aligned horizontally, then, in a Step 46 a distance measurement is carried out. For this, both the devices 29 send out laser signals, which are reflected by the reflectors 30 and then received by the devices 29. From the time taken by these laser signals to complete the journey, the distance of the concerned load handling devices 19, 20 from the travel carriage 13 can be calculated. The above mentioned distances will be saved as reference-distances L1ref, L2ref by the control unit, wherein the names “1” and “2” refer to the respective load handling devices 19, 20. Furthermore, the height H is saved by the control unit.

Owing to the inaccuracies that could arise while approaching the two load handling devices 19, 20 to the height H as described above, for instance, due to the inaccuracies in converting the angular position of the hoisting drums to the wound up length of the supporting cables 17, 18, it is possible that the two reference-distances L1ref, L2ref could differ. In this case the supporting cables 17, 18 can be wound onto or unwound from one of the two load handling devices 19, 20 during a Step 47, depending on the difference Ldref of the two reference-distances L1ref, L2ref in such a way that this difference Ldref is compensated and the two load handling devices 19, 20 are actually at the same height, in particular, at the height H.

It should be noted that the Step 47 explained above need not necessarily be executed after or together with one of the Steps 45 and/or 46. It is also possible to execute the Step 47 independent of the Steps 45 or 46 at any other instants of time or to take the explained difference Ldref between the two reference-distances L1ref, L2ref into consideration in any other manner as well.

If reference-inclinations and reference-distances are saved in the control unit, then, while operating the loading device a coupling of the two load handling devices 19, 20 can be done with the help of the control unit, as explained below with the help of the FIG. 2c.

In a Step 51 the two load handling devices 19, 20 are moved to the configured height H. This is done by the control unit through a corresponding actuation of the electric motors that actuate the hoisting drums. The height H of the respective load handling devices 19, 20 is thus adjusted with the help of the corresponding hoisting drums, with which the supporting cables 17 of the concerned load handling device 19, 20 are wound up or unwound. As explained already, here, a sensor that records the angular position of the hoisting drums can be provided or the electric motor can be designed as a step motor.

In a Step 52, then, each of the two load handling devices 19, 20 is aligned in the horizontal plane. This is done in each case as per the Step 42 which was explained.

If the load handling devices 19, 20 are at the height H and are aligned horizontally, then, a distance measurement is carried out in a Step 53. For this purpose, laser signals are emitted by the two devices 29, reflected by the reflectors 30 and then received again by the devices 29. From the time taken by these laser signals to complete the trajectory, the distance of the concerned load handling device 19, 20 from the travel carriage 13 can be calculated. The above mentioned distances are saved as current distances L1 (ti), L2 (ti) by the control unit, wherein the terms “1” and “2” refer to the respective load handling devices 19, 20, and wherein the term “ti” refers to the instant i at which the distance is measured.

It is now possible that the supporting cables 17, 18 were or are subjected to an elongation during the operation of the loading device as a result of the container movement. This elongation can be different at the two load handling devices 19, 20, and in particular, if one of the two load handling devices 19, 20 alone is used and the other load handling devices 20, 10 is not used during this time. As a result of the said elongation of the supporting cables 17, 18 of the two load handling devices 19, 20 it may happen that the two current distances L1 (ti), L2 (ti) may differ.

The control unit calculates the following differences during Step 53:

L1d=L1ref−L1 (ti)

L2d=L2ref−L2 (ti),

wherein the terms “1” and “2” in the differences L1d, L2d again refer to the respective load handling devices 19, 20.

After this the electric motors that drive the hoisting drums of the two load handling devices 19, 20 are actuated in such a way by the control unit that the said differences L1d, L2d tend to zero.

This can be achieved by compensating the corresponding difference L1d or L2d at each of the load handling devices 19, 20. In this case, then, the two load handling devices 19, 20 are at the height H. Alternatively, this can also be achieved by comparing the two differences L1d, L2d with each other and, depending on the result of comparison Ld, actuating only one of the two load handling devices 19, 20 in such a way that the result of comparison Ld tends to zero. In this case the two load handling devices are at the same height, but not necessarily at the height H.

Independent of this, while actuating the load handling devices 19, 20 even the inaccuracies that were explained earlier, and which could arise at the time of moving the two load handling devices 19, 20 to the height H, can be taken into consideration. In particular an existing difference Ldref between the two reference-distances L1ref, L2ref can be compensated through a corresponding actuation.

It should be noted that the compensation of the two reference-distances L1ref, L2ref and the compensation of the two differences L1d, L2d can also be combined with each other. Here, if necessary, it is possible to carry out the compensation at only one of the two load handling devices 19, 20.

After executing the Step 53 the two load handling devices 19, 20 will be at the same height, wherein this height need not necessarily be the height H, as explained already. Furthermore, the two load handling devices 19, 20 are aligned in the horizontal plane. The two load handling devices 19, 20 can then be mechanically coupled with each other.

The method as per the FIG. 2c can be repeated at any time. The balancing or compensating transactions can be aimed at the reference-distances L1ref, L2ref as explained. In an embodiment, however, it is also possible to take into account the compensating processes of a previous execution of the process show in FIG. 2c, so that only a deviation from this preceding execution will have to be compensated.

The differences L1d, L2d that would correspond to the two load handling devices 19, 20 corresponding represent the elongation of the supporting cables 17, 18 of the two load handling devices 19, 20 and hence represent the wear and tear of the supporting cables 17, 18 with the passage of time. The differences L1d, L2d could be used for maintenance purposes, for instance, with regard to a replacement of the supporting cables 17, 18.

An embodiment would dispense with the determination of the reference-distances L1ref, L2ref. In this case, inaccuracies that are expressed in the difference Ldref, cannot be compensated. In this case, only the current distances L1 (ti), L2 (ti) are determined and the control unit will compute a difference Ld (ti) depending on these latest distances. After this at least one of the two load handling devices 19, 20 is actuated in such a way that the difference Ld (ti) tends to zero. The two load handling devices 19, 20 will then be at the same height.

This written description uses examples to disclose the invention, including the best mode, and also to enable any person skilled in the art to practice the invention, including making and using any computing system or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A loading device for containers, the loading device comprising:
a travel carriage;
two load handling devices fixed, with the aid of supporting cables, to the travel carriage, wherein each of the two load handling devices can be raised or lowered, and the two load handling devices can be coupled mechanically with each other; and
distance sensors, wherein at least one of the distance sensors is assigned to each of the two load handling devices, and each of the distance sensors is configured to determine the distance of the assigned load handling device from the travel carriage.

2. The loading device of claim 1, wherein an elongation of the supporting cables does not have any influence on the determination of the distance of the assigned load handling device from the travel carriage by the distance sensors.

3. The loading device of claim 1, wherein at least one of the distance sensors is a contact free device.

4. The loading device of claim 3, wherein at least one of the distance sensors is an optic sensor.

5. The loading device of claim 1, wherein at least one of the distance sensors comprises a device configured to send and receive laser signals and a reflector, and wherein the device is attached to the travel carriage and the reflector is attached to the assigned load handling device.

6. The loading device of claim 1, further comprising an inclination sensor configured to determine a spatial orientation of the two load handling devices with respect to a horizontal plane.

7. The loading device of claim 6, wherein the inclination sensor is configured to scan a surface and to record a deviation of the surface with respect to the horizontal plane.

8. A method for operating a loading device for containers, wherein the loading device comprises a travel carriage, two load handling devices fixed, with the aid of support cables, to the travel carriage, wherein each of the two load handling devices can be raised or lowered, and the two load handling devices can be coupled mechanically with each other, and distance sensors, wherein at least one of the distance sensors is assigned to each of the two load handling devices, and each of the distance sensors is configured to determine the distance of the assigned load handling device from the travel carriage, the method comprising:
determining a present distance for each of the two load handling devices from the travel carriage;
determining a difference based on the present distance; and
raising or lowering at least one of the two load handling devices so that the difference tends to zero.

9. The method of claim 8, further comprising:
determining a reference distance for each of the two load handling device;
determining a reference difference between the reference distance and the present distance for each of the two load handling device; and
raising or lowering at least one of the two load handling devices so that the reference difference tends to zero.

10. The method of claim 8, further comprising:
determining a reference distance for each of the two load handling devices;
determining a reference difference between the reference distance and the present distance for each of the two load handling devices;
determining a comparative result from the reference differences of the two load handling devices; and
raising or lowering at least one of the two load handling devices so that the comparative result tends to zero.

11. The method of claim 8, further comprising:
determining a present difference from the two present distances of the two load handling devices; and
raising or lowering at least one of the two load handling devices so that the present difference tends to zero.

12. The method of claim 8, further comprising:
determining a spatial orientation of the two load handling devices with respect to a horizontal plane by an inclination sensor; and
adjusting the supporting cables in a way that the two load handling devices are in the horizontal plane.

13. The method of claim 12, further comprising:
determining reference inclinations;
determining actual inclinations by the inclination sensor;
comparing the reference inclinations with the actual inclinations; and
adjusting the supporting cables based on a result of the comparison.

14. The method of claim 13, wherein the spatial orientation of the two load handling devices with respect to the horizontal plane or the result of the comparison is converted by a characteristic curve to a displacement path of a working cylinder that can be actuated hydraulically.

15. A control unit for operating a loading device for containers, wherein the loading device is the loading device of claim 1, and the control unit is configured to execute the method of claim 8.
